(19) United States
(12) Patent Application Publication
(10) Pub. No.: US 2008/0100712 A1
(43) Pub. Date: May 1, 2008

(54) Camera with Integrated Wireless Interface

(75) Inventors: Gerard J. Hayes, Wake Forest, NC (US); Ronald A. Louks, Durham, NC (US)

Correspondence Address: COATS & BENNETT/SONY ERICSSON, 1400 CRESCENT GREEN, SUITE 300, CARY, NC, 27511, US

(73) Assignee: SONY ERICSSON MOBILE COMMUNICATIONS AB, Lund (SE)

(21) Appl. No.: 11/613,689

(22) Filed: Dec. 20, 2006

Related U.S. Application Data
(60) Provisional application No. 60/863,374, filed on Oct. 29, 2006.

(51) Int. Cl. H04N 5/225; H04N 9/04

(52) U.S. Cl. 348/207.99

(57) ABSTRACT

In one or more embodiments taught herein, a camera comprises a camera body, a flip-out display member coupled to the camera body, and a wireless interface module and one or more associated antennas incorporated into the flip-out display member. The wireless interface module may be integrated within the flip-out display member, or may be removably mounted in it. In such configurations, the flip-out display member 14 includes a receptacle, such as a slot-type receptacle or a snap-in type receptacle, to receive the wireless interface module, which may be configured as a PC card or PCI Mini card, for example. Whether removable or not, the wireless interface module may support one or more cellular and/or wireless LAN standards, such as GSM/GPRS, WCDMA, cdma2000, Bluetooth, Wi-Fi, WiMax, etc. Complementing the wireless interface's communications capability, the antenna(s) may comprise fixed or movable antennas configured for diversity/MIMO operation, and/or operation in different frequency bands.

### RELATED APPLICATIONS

This application claims the benefit of U.S. Provisional Patent Application 60/863,374 filed Oct. 29, 2006, which is incorporated herein by reference.

### BACKGROUND

The present invention generally relates to cameras, such as video cameras, and particularly relates to the advantageous incorporation of wireless interfaces into cameras.

Cameras as much as any other consumer or professional electronic item reflect ongoing technological advances. Each camera generation betters the previous one in terms of resolution, features, size, battery life, etc. Contemporary examples include the palm-sized digital video recorders offered by companies such as SONY. Such cameras typically offer a host of user features, and commonly include direct-to-disc digital recording. More generally, virtually all such cameras includes the lens, imaging sensors, processing and control electronics, and removable recording media (and media drive), all within a camera body that provides less room with each generational reduction of camera form factor.

The lack of space within the camera body presents challenges when contemplating additional features. For example, the use of digital video cameras as a means of capturing digital video for transfer to a home computer and/or remote server is commonplace. The common approach to transferring camera data involves the use of a wired connection, such as USB or FIREWIRE, and most cameras include at least one wired connection for data transfer.

Wireless interfacing would provide greater convenience, but the small form factors and correspondingly crowded interiors of contemporary cameras make the additional wireless interface circuits and associated antennas impractical, or at least undesired. For example, packaging constraints may compromise radiofrequency (RF) circuit and/or antenna placement, and therefore compromise wireless performance.

### SUMMARY

In at least one embodiment taught herein, a camera comprises a camera body, a flip-out display member coupled to the camera body, and a wireless interface module and one or more associated antennas incorporated into the flip-out display member. In at least one such embodiment, the wireless interface module is fixedly integrated within the flip-out display member. In one or more other embodiments, the wireless interface module removably mounts within a receptacle included in the flip-out display member. In at least one such embodiment, the receptacle, which may require removing a cover or partially disassembling the flip-out display member for access, comprises a Mini PCI receptacle and the wireless interface module comprises a PCI Mini card, which snaps into the receptacle and to which the associated antennas connections can be made.

Whether the wireless interface module is removable or fixedly integrated, the one or more antennas incorporated in the flip-out display member are configured in at least one embodiment for diversity operation, and the wireless interface module includes corresponding diversity receiver and/or transmitter circuits. In at least one such embodiment, a first antenna is fixedly mounted within the flip-out display unit, and a second antenna is pivotally mounted, such that it overlies the first antenna in one position, but pivots into an orthogonal position. As such, the first and second antennas may operate with orthogonal polarizations for diversity or multiple-input-multiple-output (MIMO) reception and/or transmission operations.

Thus, incorporating the wireless interface antenna(s) into the flip-out display member offers a number of advantageous configurations. Correspondingly, a method of incorporating a wireless interface module into a camera having a flip-out display member coupled to a body of the camera comprises incorporating the wireless interface module and one or more associated antennas into the flip-out display member. A further method embodiment includes incorporating at least two fixed or movably mounted antennas in the flip-out display member, for diversity and/or MIMO operations, or for operating at different frequency bands of interest.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIGS. 1 and 2 are front and rear perspective views of one embodiment of a camera having a wireless interface module and associated antenna(s) incorporated within a flip-out display member of the camera.

FIG. 3 is a block diagram of one embodiment of a wireless interface module and corresponding camera circuits.

FIG. 4 is a block diagram of another embodiment of wireless interface module and corresponding camera circuits.

FIG. 5 is a block diagram of a camera that includes a wireless interface module, and of one or more remote devices or systems accessible to the camera via wireless signaling.

FIG. 6 is a perspective view of one embodiment of a camera and illustrates one embodiment of the antenna(s) incorporated into the flip-out display member of the camera.

FIG. 7 is a perspective view of one embodiment of a camera and illustrates another embodiment of the antenna(s) incorporated into the flip-out display member of the camera.

FIG. 8 is a perspective view of a camera's flip-out display member (shown without the camera for simplification), and illustrates another embodiment of the antenna(s) incorporated into the flip-out display member.

FIG. 9 is a perspective view of a camera's flip-out display member (shown without the camera for simplification), and illustrates a removable embodiment of the wireless interface module.

FIG. 10 is a back view of a camera's flip-out display member (shown without the camera for simplification), and illustrates a slot-type receptacle for receiving a removable embodiment of the wireless interface module.

FIG. 11 is a side view of the flip-out display member and removable wireless interface module of FIG. 10.

### DETAILED DESCRIPTION

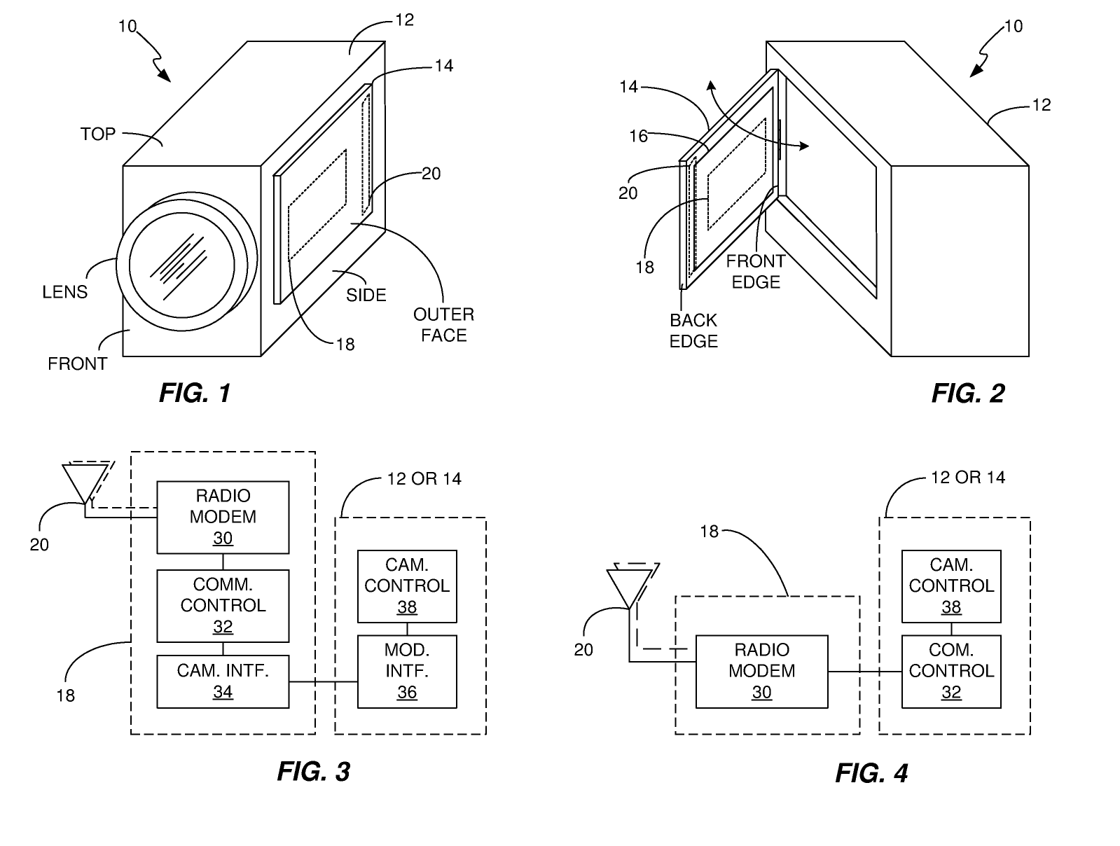

FIG. 1 illustrates a camera 10, e.g., a video camera, having a camera body 12 and a flip-out display member 14 that pivots outward from a side of the camera body 12 to reveal a display screen 16 on an inner face of the flip-out display member 14, as shown in FIG. 2. Further, as shown in FIG. 1, one or more camera embodiments include a front-mounted lens.

However, of particular interest in this disclosure, one or more method and apparatus embodiments taught herein incorporate a wireless interface module 18 and one or more associated antennas 20 into the flip-out display member 14. Incorporating these wireless communication elements into the flip-out display member 14 offers numerous advantages, such as avoiding the need to add circuitry to the typically crowded interior of the camera body 12, while providing advantageous antenna positioning and configuration operations.

FIG. 3 depicts one embodiment of the wireless interface module 18, as incorporated into the flip-out display member 14. In the illustrated embodiment, the wireless interface module 18 is operatively associated with one or more antennas 20 (also carried in or mounted on the flip-out display member 14), and includes a radio modem circuit 30, a communication control circuit 30, and a camera interface circuit 34.

With communication control circuits 32 included in the wireless interface module 18, it is not necessary for the module interface circuit 36 or the camera control circuit 38 to manage wireless communication functions (e.g., physical, MAC, link, and application layers). Instead, in at least one such embodiment, the wireless “intelligence” is embedded in the wireless communication module 18. That approach simplifies basic camera design and, in embodiments where the wireless interface module 18 is removable from the flip-out display member 14 rather than integrated within it, radio protocols, application functionality, or other features, may be changed by swapping one wireless interface module 18 for another.

Of course, in other removable embodiments of the wireless interface module 18, at least some of the applications-level wireless communications intelligence resides within the camera 10, and wireless interface module 18 may function simply as a radio modem. For example, FIG. 4 illustrates an alternative embodiment, wherein the wireless interface module 18 comprises the radio modem 30, and at least a portion of the higher-level communication control circuits 32 are included in the camera body 12, or elsewhere in the flip-out display member 14. (Note that the communication control circuits 32 in this illustration include radio modem interface circuits as needed.)

In any case, the wireless interface module 18 enables transfer of camera data (live/recorded images, settings, etc.) via wireless signaling. Further, those skilled in the art will appreciate that FIGS. 3 and 4 illustrate just two example embodiments, and that potentially many other architectural variations may be implemented without departing from the basic configuration of carrying wireless communication circuitry within the flip-out display member 14. Architectural flexibility particularly arises with the use of highly integrated circuits, wherein one or more microprocessors, microcontrollers, digital signal processors, or other digital processing circuits integrate a range of functional features and device operations. As such, FIGS. 3 and 4 should be understood as illustrative functional arrangements, and not necessarily as physical circuit implementations.

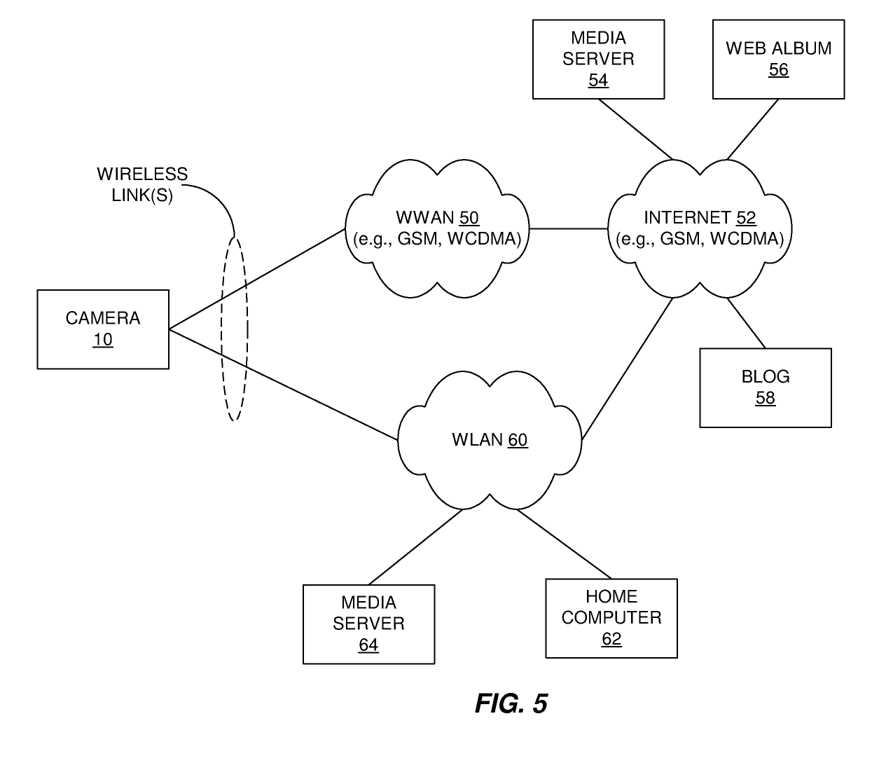

Regardless of the particular circuit arrangements adopted, FIG. 5 illustrates possible usage scenarios, wherein the wireless interface module 18 within the camera 10 supports wireless communication links with one or more local and/or remote systems. For example, in at least one embodiment, the wireless interface module 18 includes a cellular communication transceiver (e.g., the radio modem 30 comprises a GSM/GPRS, WCDMA, cdma2000, or other cellular transceiver) that enables wireless signaling between the camera 10 and a wireless wide area network (WWAN) 50. In turn, WWAN 50 communicatively couples one or more software applications running in the camera 10 to one or more remote devices or systems accessible via the Internet 52. By way of non-limiting example, such devices or systems include a media server 54, a web album server 56, and a blog server 58. Thus, a user of the camera 10 can transmit recorded or live camera images to remote destinations via its wireless link to the Internet 52.

Additionally, or alternatively, the wireless interface module 18 within the camera 10 includes radio transceiver circuits that support one or more wireless local area network (WLAN) standards or other WWAN standards, such as Bluetooth, Wi-Fi, Wi-Max, etc. Such support enables the camera 10 to establish wireless links with a WLAN 60. In the illustration, the WLAN 60 communicatively couples the camera 10 to one or both a personal computer (PC) 62 and a media server 64.

The above examples offer non-limiting illustrations of the types of wireless radio links that may be supported by the wireless interface module 18. In turn, the type(s) of radio links supported influences the configuration of the one or more antennas 20 incorporated into the flip-out display member 14 in association with the wireless interface module 18.

For example, certain communication standards require diversity reception, at least for higher data rates. The IEEE 802.11n standards based on multiple-input-multiple-output (MIMO) transmission and reception represent a non-limiting example of the need for multiple antennas 20. As such, in at least one embodiment, the one or more associated antennas 20 comprise at least first and second antennas that are operatively associated with diversity receiver and/or transmitter circuits in the wireless interface module 18. Of course, the wireless interface module 18 may utilize multiple antennas 20, even in instances where a single remote transmitting antenna is involved.

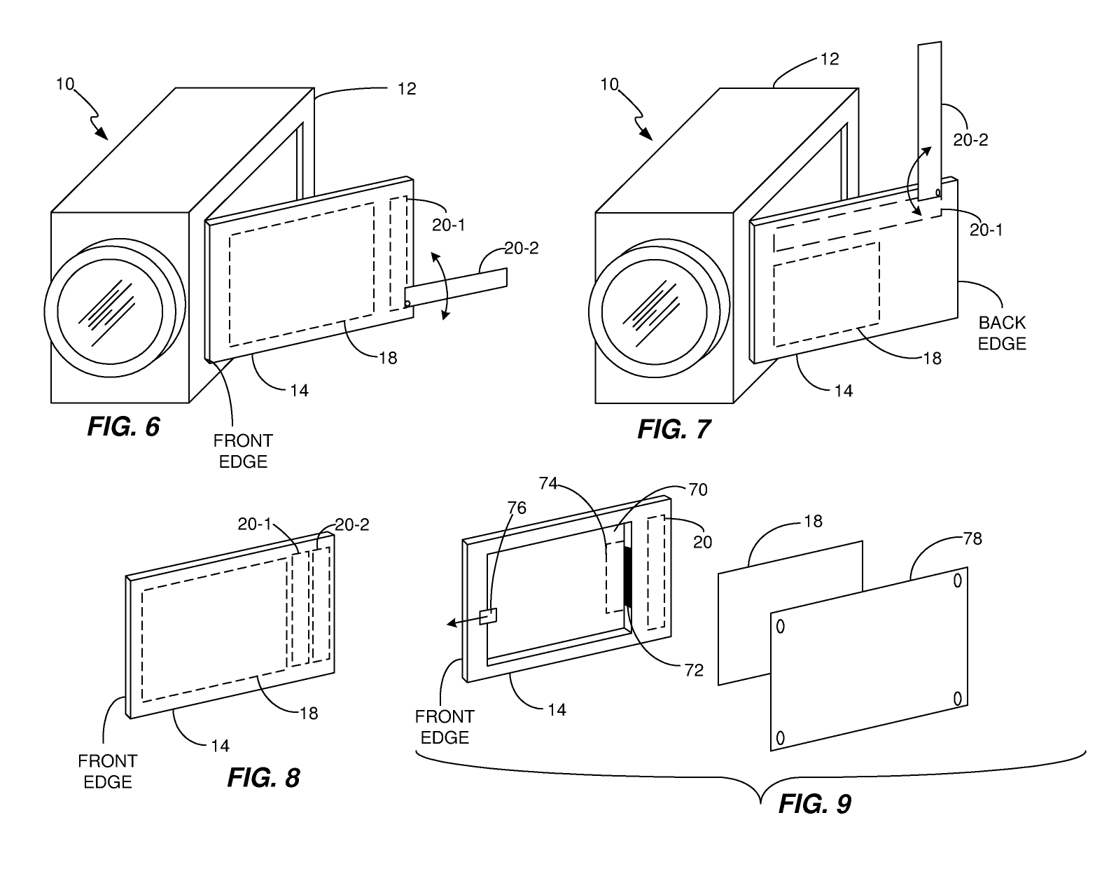

FIG. 6 offers one illustration of advantageous use of the flip-out display member 14 for carrying the wireless interface module 18, and particularly illustrates the advantages offered for antenna placement and configuration in one embodiment. More particularly, antennas 20-1 and 20-2 comprise first and second antennas configured for operation with orthogonal polarizations.

The first antenna 20-1 is fixedly integrated along a back edge of the flip-out display member 14. (For reference, the front-edge of the flip-out display member couples the flip-out display member to the camera body, as shown in FIGS. 1 and 2, for example.) Thus, the back edge of the flip-out display member 14 is the distal edge—i.e., the edge located away from the point of hinged or pivoting attachment to the camera body 12.

With the above configuration of the first antenna 20-1, the second antenna 20-2 is operatively associated with the first antenna 20-1 and pivotally connected to the back edge of the flip-out display member 14. With this configuration, the second antenna 20-2 overlies the first antenna 20-1 when pivoted into its closed position, and is orthogonal to the first antenna 20-1 when pivoted into its open position.

FIG. 7 illustrates a similar orthogonal antenna arrangement, but where the first antenna 20-1 is fixedly integrated along a top edge of the flip-out display member 14. With that placement, the second antenna 20-2 is operatively associated with the first antenna 20-1 and pivotally connected to the top edge of the flip-out display member 14. As such, the second antenna 20-2 overlies the first antenna 20-1 when pivoted into its closed position, and is orthogonal to the first antenna 20-1 when pivoted into its open position.

FIG. 8 illustrates another antenna configuration, wherein first and second antennas 20-1 and 20-2 are positioned near the back edge of the flip-out display member 14. (The illustration shows them in a side-by-side arrangement, but that is a non-limiting configuration). One or both of these antennas 20-1 and 20-2 may be pivotally or slidably mounted to the flip-out display member 14, and, irrespective of that detail, each such antenna may be configured for a different operating frequency band. That is, in one embodiment, the first antenna 20-1 is configured for a first operating frequency band, while the second antenna 20-2 is configured for a second operating frequency band. With this configuration, the wireless interface module 18 uses the appropriate antenna in dependence on the particular operating frequency range of the desired communications.

Other embodiments contemplated herein adopt a similar antenna arrangement for horizontal antenna placement along the top edge of the flip-out display member 14. Of course, while not explicitly shown, a first antenna 18-1 can be fixedly or movably vertically mounted along the back (or front) edge of the flip-out display member 14, while a second antenna 18-2 is fixedly or movably mounted in a horizontal configuration along a top (or bottom) edge of the flip-out display member 14. In such configurations, the two antennas may be operatively associated for diversity/MIMO operation, or may function independently, for use at different operating frequency bands of interest, and the wireless interface module 18 includes correspondingly configured radio transceiver circuits.

Broadly, then, it should be understood that at least one antenna 20 is incorporated into the flip-out display member 14, and is operatively associated with the wireless interface module 18. The at least one antenna 20 may be fixedly or movably mounted (pivot/swivel, slide, etc.). The at least one antenna 20 can be positioned vertically along front or back edges of the flip-out display member 14, or positioned horizontally along top or bottom edges of the flip-out display member 14. If more than one antenna is implemented, they may be co-located in an parallel overlying configuration, and at least one of them may be configured to swivel into an orthogonal position for orthogonal polarization.

Turning from the above antenna configuration examples, FIG. 9 illustrates an embodiment wherein the flip-out display member 14 includes a wireless interface card receptacle 70 that is accessible from the outer face-i.e., the face exposed when the flip-out display member is in its closed position. Another embodiment contemplated herein places the receptacle 70 on the inner face of the flip-out display member 14. In either embodiment, the wireless interface module 18 is removable from the flip-out display member 14, rather than being fixedly integrated within it as in other embodiments.

In at least one removable embodiment, the wireless interface module 18 comprises a wireless interface card, which may be a full-featured card including radio communication circuits and higher-layer processing circuits (e.g., one or more microprocessors and associated memory storing one or more applications that support wireless transfer of camera data.) In other such embodiments, the wireless interface module 18 functions simply as a radio modem, and the applications intelligence resides in other circuits retained within the flip-out display member 14 and/or the camera body 12.

Regardless, the wireless interface card configuration allows the wireless interface module 18 to be inserted in and removed from the receptacle 70. In some embodiments, the receptacle 70 comprises a snap-in type receptacle, while in other embodiments it comprises a slide-in type receptacle. In one or more embodiments, the receptacle 70 provides electrical interconnection with the wireless interface module 18 via a slot/socket connector 72 and/or an array of upward facing contacts 74. Additionally, the receptacle 70 may further include or be associated with a retaining tab 76 that slides into locking engagement with the wireless interface module 18.

In at least one such embodiment, a removable cover 78 covers a PCI Mini card embodiment of the receptacle 70, and the wireless interface module 18 snaps into or otherwise mates with the receptacle 70 and provides terminating connectors for the one or more associated antennas 20, which can be connected with the antennas 20 as part of the installation process. After installation, the cover 78 may be fastened back over the exposed receptacle 70/wireless module 18. Note that the cover 78 and/or its fastening hardware may be configured in such a way to limit access to the receptacle 70. Note, too, that the other configurations may be used for positioning the receptacle 70 within an interior of the flip-out display member 14.

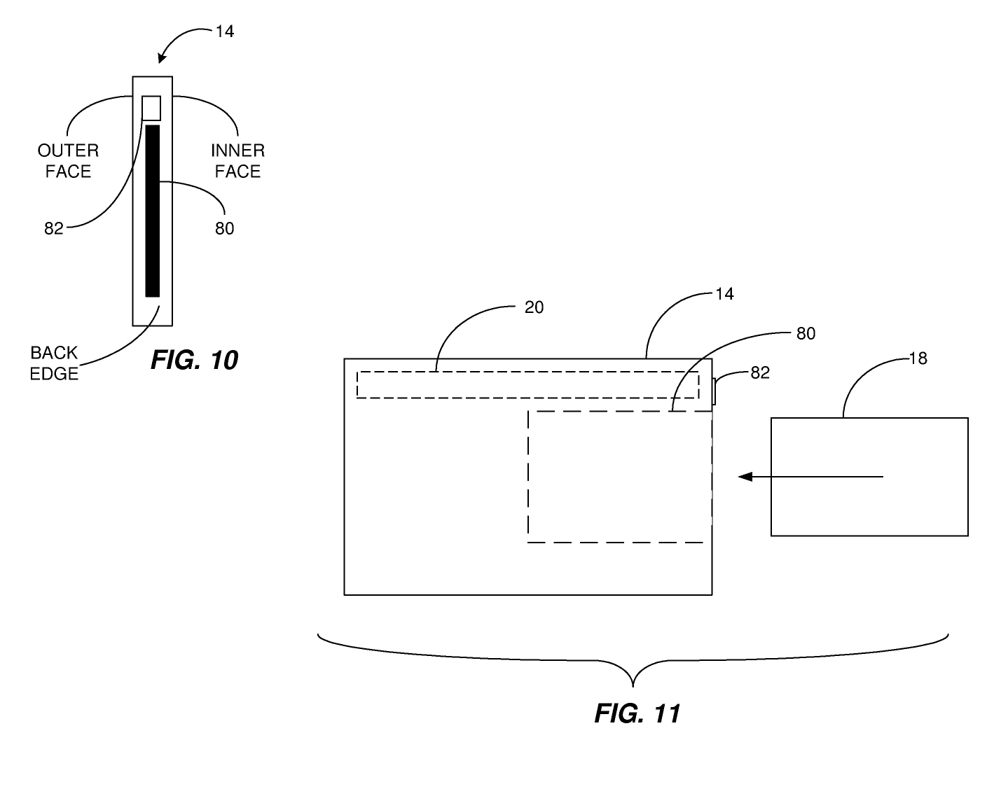

FIGS. 10 and 11 illustrate another configuration, wherein the wireless interface module 18 also is configured as a wireless interface card and removably mounts within the flip-out display member 14. As shown in FIG. 10, the back edge of the flip-out display member 14 includes a slot-type receptacle 80, e.g., a card slot, for inserting the wireless interface module 18. An ejection button or lever 82 also may be included, to facilitate removal of the wireless interface module 18 from the slot 80.

With the above examples in mind, it should be understood that the wireless interface module 18 may comprise circuitry that is fixedly integrated within the flip-out display member 14. For example, it may be included on circuit boards fixed within the flip-out display member 14. In other embodiments, the wireless interface module 18 comprises a removable module, although in some removable module embodiments, installation and removal may not be practicable or even authorized for end-users of the camera 10. In one non-limiting removable module embodiment, the flip-out display member 14 can be partially disassembled, e.g., a cover 78 can be removed, to gain access to a module receptacle 70, which may be configured as a PCI Mini card receptacle. In such an embodiment, the wireless module 18 is configured as a PCI Mini card that snaps into the receptacle 70 and connects with the antenna(s) 20.

Of course, regardless of the wireless interface card form factor adopted for the wireless interface module 18, it can be configured for one or more types of wireless communication. Further, different cards having differing communication capabilities may be manufactured and sold.

With all of the above apparatus embodiments in mind, a broad embodiment of a method of incorporating a wireless interface module 18 into a camera 10 having a flip-out display member 14 coupled to a body 12 of the camera comprises incorporating the wireless interface module 18 and one or more associated antennas 20 into the flip-out display member 14. At least one method embodiment further comprises configuring the one or more associated antennas 20 as first and second antennas 20-1 and 20-2 for operation at different frequency bands of interest, or for diversity reception and/or transmission operation. In at least one embodiment, the method comprises configuring the first antenna 20-1 as a fixedly mounted antenna and configuring a second antenna 20-2 as a pivotally mounted antenna that swivels into an orthogonal position relative to the fixedly mounted antenna.

Other method embodiments include configuring the wireless interface module 18 as an integrated circuit arrangement carried within the flip-out display member 14. An alternative method embodiment configures the wireless interface module as a removable assembly, such as a wireless interface card, in which case, the flip-out display member 14 is configured to include a wireless interface card receptacle 70 (or 80) for receiving the wireless interface card in a snap-in or slide-in configuration.

With the many apparatus and method examples given above, those skilled in the art will appreciate that the present invention is not limited by the foregoing description and accompanying drawings. Instead, the present invention is limited only by the claims and their legal equivalents.

What is claimed is:

1. A camera comprising:
a camera body;
a flip-out display member coupled to the camera body; and
a wireless interface module and one or more associated antennas incorporated into the flip-out display member.

2. The camera of claim 1, wherein the camera comprises a video camera having a forward lens disposed in a front portion of the camera body, and wherein the flip-out display member is hingedly integrated into a side portion of the camera body.

3. The camera of claim 1, wherein the flip-out display member includes a wireless interface card receptacle and wherein the wireless interface module comprises a wireless interface card removably mountable in the wireless interface card receptacle.

4. The camera of claim 3, wherein the wireless interface card receptacle is disposed within an interior space of the flip-out display member.

5. The camera of claim 3, wherein the flip-out display member includes a removable cover portion that provides access to the wireless interface card receptacle.

6. The camera of claim 3, wherein the wireless interface card receptacle comprises a card slot receptacle disposed in a back edge of the flip-out display member, wherein a front edge of the flip-out display member is coupled to the camera body.

7. The camera of claim 3, wherein the wireless interface card comprises a wireless modem card.

8. The camera of claim 3, wherein the wireless interface card receptacle comprises a Peripheral Component Interconnect (PCI) Mini Card receptacle and the wireless interface card comprises a PCI Mini Card.

9. The camera of claim 1, wherein the wireless interface module includes at least one of a Bluetooth, Wi-Fi, WiMax, and cellular wireless communication interface.

10. The camera of claim 1, wherein the wireless interface module is fixedly integrated in the flip-output display member.

11. The camera of claim 1, wherein the one or more antennas incorporated into the flip-out display member comprise a movable first antenna.

12. The camera of claim 11, further comprising a fixed second antenna configured to operate in conjunction with the movable first antenna.

13. The camera of claim 1, wherein the one or more antennas incorporated into the flip-out display member comprise first and second antennas configured for operation with orthogonal polarizations.

14. The camera of claim 13, wherein the wireless interface module includes receiver or transmitter circuits configured for diversity operation via the first and second antennas.

15. The camera of claim 1, wherein the one or more antennas incorporated into the flip-out display member comprise first and second antennas having first and second operating frequency bands.

16. The camera of claim 15, wherein the wireless interface module includes receiver or transmitter circuits configured for operation in the first and second operating frequency bands.

17. The camera of claim 1, wherein the one or more antennas incorporated into the flip-out display member comprise two or more antennas configured to provide diversity reception.

18. The camera of claim 1, wherein the one or more antennas incorporated into the flip-out display member comprise a fixedly mounted first antenna and a slidably or pivotally mounted second antenna.

19. The camera of claim 1, wherein the one or more antennas incorporated into the flip-out display member comprise a first antenna fixedly integrated along a top edge of the flip-out display member.

20. The camera of claim 19, further comprising a second antenna operatively associated with the first antenna and pivotally connected to the top edge of the flip-out display member, such that it overlies the first antenna when pivoted into its closed position, and is orthogonal to the first antenna when pivoted into its open position.

21. The camera of claim 1, wherein the one or more antennas incorporated into the flip-out display member comprise a first antenna fixedly integrated along a back edge of the flip-out display member, wherein a front-edge of the flip-out display member is coupled to the camera body.

22. The camera of claim 21, further comprising a second antenna operatively associated with the first antenna and pivotally connected to the back edge of the flip-out display member, such that it overlies the first antenna when pivoted into its closed position, and is orthogonal to the first antenna when pivoted into its open position.

23. The camera of claim 1, wherein the camera includes one or more communication control circuits configured to control wireless communications via the wireless interface module, and wherein the wireless interface module comprises a radio modem operating under control of the one or more communication control circuits in the camera.

24. The camera of claim 1, wherein the wireless interface module includes communication control circuits configured to control wireless communications and further includes a camera interface circuit to provide transfer of data into or out of the camera via the wireless interface module.

25. A method of incorporating a wireless interface module into a camera having a flip-out display member coupled to a body of the camera, the method comprising incorporating the wireless interface module and one or more associated antennas into the flip-out display member.

26. The method of claim 25, further comprising configuring the one or more associated antennas as a first antenna for wireless communication in a first operating frequency band and a second antenna for wireless communication in a second operating frequency band.

27. The method of claim 25, further comprising configuring the one or more associated antennas as first and second diversity antennas.

28. The method of claim 27, further comprising configuring the first antenna as a fixedly mounted antenna and configuring the second antenna as a pivotally mounted antenna that swivels into an orthogonal position relative to the fixedly mounted antenna.

29. The method of claim 25, wherein the wireless interface module comprises a radio modem, and further comprising integrating communication control circuits within the camera to control the radio modem.

30. The method of claim 25, wherein the wireless interface module comprises a wireless interface card, and further comprising configuring the flip-out display member with a wireless interface card receptacle for receiving the wireless interface card.

31. The method of claim 30, wherein configuring the flip-out display member with a wireless interface card receptacle for receiving the wireless interface card comprises configuring an inner or outer face of the flip-out display member with a snap-in or slide-in card receptacle.

32. The method of claim 30, wherein configuring the flip-out display member with a wireless interface card receptacle for receiving the wireless interface card comprises configuring a back edge of the flip-out display member to include a slot receptacle for insertion of the wireless interface card.
